(19) United States
(12) Patent Application Publication
(10) Pub. No.: US 2023/0246171 A1
(43) Pub. Date: Aug. 3, 2023

(54) Anode Electrode Protective Layer for Lithium-ion Batteries

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 17/649,245

(22) Filed: Jan. 28, 2022

(51) Int. Cl. H01M 4/36; H01M 10/0525; H01M 4/62; H01M 4/04; H01M 10/0562; H01M 10/0565

(52) U.S. Cl. CPC H01M 4/366; H01M 10/0525; H01M 4/628; H01M 4/0402; H01M 4/364; H01M 4/622; H01M 4/625; H01M 4/626; H01M 10/0562; H01M 10/0565; H01M 2004/027

(57) ABSTRACT

Provided is a lithium-ion cell comprising an anode, a cathode, a separator that electrically separates the anode and the cathode, and an elastic, ion-conducting polymer protective layer disposed between the anode and the separator, wherein the anode comprises multiple particles of an anode active material, an optional conductive additive, and an optional polymer binder that bonds the anode material particles and conductive additive together to form the anode and wherein the polymer protective layer comprises an elastic polymer having a recoverable tensile strain from 5% to 1,000%, when measured without an additive dispersed in the elastic polymer, and a lithium ion conductivity no less than 10⁻⁶ S/cm (preferably greater than 10⁻⁴ S/cm). Also provided is a method of producing such a cell.

### FIELD

The present disclosure relates generally to the field of lithium-ion battery and, more particularly, to the lithium-ion battery anode and a method of manufacturing same.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the anode layer is used to bond the anode active material (e.g., graphite or Si particles) and a conductive filler (e.g., carbon black particles or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically, the former three materials form a separate, discrete anode active material layer (or, simply, anode layer) and the latter one forms another discrete layer.

A binder resin (e.g., PVDF or PTFE) is also used in the cathode to bond cathode active materials and conductive additive particles together to form a cathode active layer of structural integrity. The same resin binder also acts to bond this cathode active layer to a cathode current collector.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during charges/discharges. Therefore, it is desirable to use a minimum amount of lithium for the formation of an effective SEI layer. In addition to SEI formation, the irreversible capacity loss Qi, can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity anode active materials, severe pulverization (fragmentation of the alloy particles) and detachment of active material particles from the resin binder occur during the charge and discharge cycles. These are due to severe expansion and contraction of the anode active material particles induced by the insertion and extraction of the lithium ions in and out of these particles. The expansion and contraction, the resulting pulverization, of active material particles and detachment from the resin binder lead to loss of contacts between active material particles and conductive additives and loss of contacts between the anode active material and its current collector. These adverse effects result in a significantly shortened charge-discharge cycle life.

To overcome some of the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g., up to a volume expansion of 380%) during the battery charge step, the protective coating is easily broken due to the mechanical weakness and/or brittleness of the protective coating materials. There has been no high-strength and high-toughness material available that is itself also lithium ion conductive.
   It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conducting (e.g., ceramic or oxide coating). It is commonly believed that the protective material should meet the following requirements: (a) The coating or matrix material should be of high strength and high stiffness that it can help to refrain the electrode active material particles, when lithiated, from expanding to an excessive extent; (b) The protective material should also have high fracture toughness or high resistance to crack formation to avoid disintegration during repeated cycling; (c) The protective material must be inert (inactive) with respect to the electrolyte, but be a good lithium ion conductor; (d) The protective material must not provide any significant amount of defect sites that irreversibly trap lithium ions; (e) The protective material must be lithium ion-conducting as well as electron-conducting. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.
      Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g., those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

In summary, the prior art has not demonstrated a composite material and other approaches that can effectively reduce or eliminate the expansion/shrinkage-induced problems of the anode active material in a lithium-ion battery. Thus, there is an urgent and continuing need for a new protective approach that enables a lithium-ion battery to exhibit a long cycle life. There is also a need for a method of readily or easily implementing such an approach in a lithium-ion battery.

Thus, it is an object of the present disclosure to develop an electrode that meets these needs and address the issues associated the rapid capacity decay of a lithium battery containing a high-capacity anode active material.

### SUMMARY

The present disclosure provides a lithium-ion cell comprising an anode, a cathode, an optional separator layer (e.g., an ion-conducting membrane, a combined separator/electrolyte layer, such as a liquid electrolyte-soaked polymer membrane, or just a solid electrolyte layer as a separator) disposed between the anode and the cathode, and an elastic and ion-conducting polymer protective layer disposed between the anode and the separator layer, if present, or between the anode and the cathode, wherein the anode comprises multiple particles of an anode active material, an optional conductive additive, and an optional polymer binder that bonds the anode material particles and the conductive additive together to form the anode and wherein the polymer protective layer comprises an elastic polymer having a recoverable tensile strain from 5% to 1,000%, when measured without an additive dispersed in the elastic polymer and a lithium ion conductivity no less than 10⁻⁶ S/cm. The polymer protective layer can serve as the separator layer (with no additional separator).

Preferably, the anode comprises pores having a pore volume fraction from 10% to 80% based on the total anode electrode volume but excluding the volume of the anode current collector, if present, in such a manner that the volume expansion of the anode electrode during battery charge/discharge operations is from 0% to 30%.

The elastic polymer typically contains a network of crosslinked chains having a desired degree of crosslinking that imparts a recoverable tensile strain from 5% to 1,000%. In some embodiments, the elastic polymer can be a thermoplastic elastomer that contains physical entanglements or phase domains holding polymer chains together when the polymer is being stressed.

In certain embodiments, the polymer protective layer comprises an elastomer or rubber selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, epichlorohydrin rubber, polyacrylic rubber, silicone rubber, polysiloxane, poly(alkyl siloxane) such as poly(methyl siloxane), fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea polymer, a copolymer thereof, a chemical derivative thereof, a sulfonated version thereof, or a combination thereof.

The elastomer or rubber may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In certain embodiments, the polymer protective layer comprises chains of a conducting conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. Preferably, these chains of a conjugate polymer are parts of a network of crosslinked chains.

Preferably, the elastic polymer permeates into pores of the anode and is in ionic or physical contact with the multiple particles of the anode active material. Preferably, the elastic polymer is in physical contact with substantially all of the anode material particles and covers most of the exposed surfaces of the anode material particles. This elastic polymer in the protective layer can help hold the electrode active material particles and the conductive additive together even when the electrode active material particles undergo large volume expansions or pulverization during battery charge/discharge operations.

In certain embodiments, the multiple anode active material particles comprise porous primary particles, porous secondary particles, or a combination of porous primary and secondary particles. The primary particles can be porous having internal pores or surface pores, as illustrated in FIG. 2(E). In some embodiments, the total pore volume fraction Vt in the anode electrode is from 20% to 70% or the volume expansion of the electrode in a battery cell during battery charge/discharge operations does not exceed 10%.

In certain embodiments, the disclosure provides an elastic polymer composition for use as an anode-protecting layer of a lithium battery, the composition initially comprising a polymerizing or cross-linking liquid precursor. The liquid precursor is capable of chemically bonding to anode active material particles in the lithium battery upon completion of polymerization or cross-linking reactions to form an elastic polymer. The polymerization and/or cross-linking reactions may be initiated and/or accelerated by using heat, UV radiation, or other forms of energy. The resulting elastic polymer has a recoverable tensile strain from 5% to 1,000% when measured without any additive or reinforcement dispersed in the polymer. Once polymerized and cured or cross-linked, the resulting polymer is chemically bonded to the anode active material and the conductive additive particles (e.g., carbon black particles, carbon nano-tubes, graphene sheets, etc.), helping to hold these particles together to maintain structural integrity.

In the disclosed anode, the conductive additive may be preferably selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

In the protective layer composition, the resulting elastic polymer (after polymerization and crosslinking) may contain a cross-linked network polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in the cross-linked network of polymer chains. These linkages or their precursor molecules may be present in the liquid precursor.

In some embodiments, the elastic polymer in the protective layer composition, after polymerization and crosslinking, contains a cross-linked network of polymer chains selected from nitrile-containing polyvinyl alcohol chains, cyano-resin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

In some embodiments, the elastic polymer, after polymerization and crosslinking, contains a cross-linked network of polymer chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. These conjugate polymer chains are parts of a network polymer.

The protective layer composition may further comprise a lithium-ion conducting material dispersed in the elastic polymer. The lithium ion-conducting material may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4. In some embodiments, the lithium ion-conducting material may be preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

In some embodiments, the lithium ion-conducting material is selected from an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

In some embodiments, the lithium ion-conducting material is selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

The elastic polymer precursor composition, after polymerization and crosslinking, may result in a high-elasticity polymer having lithium ion conductivity from 1×10⁻⁵ S/cm to 5×10⁻² S/cm and/or an electrical conductivity from 10⁻⁶ S/cm to 10³ S/cm.

In certain preferred embodiments, the elastic polymer has a lithium ion conductivity no less than 10⁻⁵ S/cm at room temperature. Preferably, the high-elasticity polymer contains a cross-linked network of polymer chains. Examples of the cross-linked networks of polymer chains were described above.

The elastic polymer has a recoverable tensile strain no less than 5% (typically 10-700%, more typically 30-500%, further more typically and desirably >50%, and most desirably >100%) when measured without an additive or reinforcement in the polymer under uniaxial tension. The polymer preferably also has a lithium ion conductivity no less than 10⁻⁵ S/cm at room temperature (preferably and more typically no less than 10⁻⁴ S/cm and more preferably and typically no less than 10⁻³ S/cm). The anode active material preferably has a specific capacity of lithium storage greater than 372 mAh/g, which is the theoretical capacity of graphite.

The elastic polymer refers to a polymer, typically a lightly cross-linked polymer network, which exhibits an elastic deformation of at least 5% when measured (without an additive or reinforcement in the polymer) under uniaxial tension. In the field of materials science and engineering, the “elastic deformation” is defined as a deformation of a material (when being mechanically stressed) that is essentially fully recoverable upon release of the load and the recovery process is essentially instantaneous. The elastic deformation is preferably greater than 30%, more preferably greater than 50%, further more preferably greater than 100%, still more preferably greater than 150%, and most preferably greater than 200%.

There is no particular limitation on the type of anode active material that can be chosen. In this anode active material layer, the anode active material may be selected from the group consisting of: (a) silicon (Si), germanium (Ge), tin (Sn), lead (Pb), phosphorus (P), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo₂O₄; (f) prelithiated versions thereof; (g) particles or fibers of carbon and graphite; (h) lithium metal or lithium alloy particles; and (i) combinations thereof.

In some preferred embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

It may be noted that pre-lithiation of an anode active material means that this material has been pre-intercalated by or doped with lithium ions up to a weight fraction from 0.1% to 54.7% of Li in the lithiated product.

There is also no particular limitation on the type of cathode active materials that can be used for practicing instant disclosure. The cathode active material particles may contain a cathode active material selected from an inorganic material, an organic material, a polymeric material, or a combination thereof. The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide (such as the well-known NMC, NCA, etc., where N═I, M=Mn, C═Co, and A=Al in these two examples), lithium iron phosphate, lithium manganese phosphate, lithium vanadium phosphate, lithium mixed metal phosphate, lithium metal silicide, or a combination thereof. The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In certain preferred embodiments, the inorganic material-based cathode active material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In certain preferred embodiments, the inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

In certain preferred embodiments, the inorganic material is selected from a transition metal dichalcogenide, a transition metal trichalcogenide, or a combination thereof. The inorganic material is selected from TiS₂, TaS₂, MoS₂, NbSe₃, MnO₂, CoO₂, an iron oxide, a vanadium oxide, or a combination thereof.

The cathode active material layer may contain a metal oxide containing vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In some embodiments, the inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The anode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the anode active material has a dimension less than 50 nm, even more preferably less than 20 nm, and most preferably less than 10 nm. However, in some embodiments, the anode active material contains a sub-micron or micron particle having a dimension from 100 nm to 30 μm.

Preferably, the anode active material, in the form of a nano particle, nano wire, nano fiber, nano tube, nano sheet, nano belt, nano ribbon, nano disc, nano platelet, or nano horn is pre-intercalated or pre-doped with lithium ions to form a prelithiated anode active material having an amount of lithium from 0.1% to 54.7% by weight of said prelithiated anode active material.

In some preferred embodiments, the anode active material layer contains voids in a sufficient amount to accommodate a volume expansion of the anode active material particles during a charge procedure of a lithium battery comprising the anode layer so that the anode layer undergoes a volume change of less than 20%, preferably less than 10%, and most preferably substantially 0%. The voids or pores may be produced by introducing a blowing agent or foaming agent into the anode electrode layer when the layer is formed.

The present disclosure also provides a method of manufacturing a lithium battery cell, the method comprising: (a) preparing an anode by (i) dispersing multiple particles of an anode active material, a conductive additive, and a resin binder in a liquid medium to form a slurry; (ii) coating or casting the slurry onto at least a primary surface of an anode current collector; and (iii) removing the liquid medium to form an anode electrode comprising an anode active layer supported on the anode current collector; (b) depositing a protective polymer layer onto a primary surface of the anode active layer to form a protected anode electrode, wherein the protective polymer layer comprises an elastic, ion-conducting polymer having a recoverable tensile strain from 5% to 1,000%, when measured without an additive or reinforcement dispersed in the polymer, and a lithium ion conductivity no less than 10⁻⁶ S/cm; and (c) combining the protected anode electrode, a separator or combined separator/electrolyte, a cathode, and a protective casing to form the lithium-ion cell.

In some embodiments, step (b) comprises the following procedures (A) and/or (B):
(A) comprises (i) dispersing or dissolving the elastic, ion-conducting polymer (optionally along with a curing agent or crosslinking agent) in a liquid solvent to form a polymer solution, (ii) spraying, casting, or coating the polymer solution onto the primary surface of the anode active layer, and (iii) removing the liquid solvent to form a dry protective layer (step (A) may optionally include a procedure of crosslinking the polymer); and/or
(B) comprises preparing a liquid reactive mixture comprising a monomer or oligomer, an initiator and/or a crosslinking agent, depositing the liquid reactive mixture onto the primary surface of the anode active layer, and effecting a polymerization and/or crosslinking procedure to form the elastic, ion-conducting polymer which is in ionic or physical contact with the multiple anode active material particles.

In some embodiments, step (a) comprises producing pores in the anode active layer and step (b) comprises permeation of the elastic polymer or its precursor into the pores so that the elastic polymer comes in ionic or physical contact with the multiple anode active material particles.

### BRIEF DESCRIPTION OF THE DRAWINGS

FIG. 1(A) Schematic of a prior art lithium-ion battery cell, wherein the anode layer is a thin coating of an anode active material itself.

FIG. 1(B) Schematic of another prior art lithium-ion battery; the anode layer being composed of particles of an anode active material, a conductive additive (not shown) and a resin binder (not shown).

FIG. 2(A) Schematic illustrating the notion that expansion of Si particles, upon lithium intercalation during charging of a prior art lithium-ion battery, can lead to pulverization of Si particles, detachment of resin binder from the particles, and interruption of the conductive paths formed by the conductive additive, and loss of contact with the current collector;

FIG. 2(B) Schematic illustrating the notion that expansion of a Si particle (coated with a non-elastic coating, such as carbon), upon lithium intercalation during charging of a prior art lithium-ion battery, can lead to a broken coating;

FIG. 2(C) Schematic illustrating an anode electrode having a protective layer of a high-elasticity polymer disposed between an anode active layer and a separator; this protective layer has an elastic polymer permeating into pores of the anode electrode and coming in contact with substantially all the anode active material particles.

FIG. 2(D) Schematic illustrating some embodiments of the present disclosure, wherein a porous secondary particle (or porous particulate) may be produced from one or multiple primary particles.

FIG. 3 Representative tensile stress-strain curves of four BPO-initiated cross-linked ETPTA polymers.

FIG. 4 Representative tensile stress-strain curves of four PF5-initiated cross-linked PVA-CN polymers.

### DETAILED DESCRIPTION

This disclosure is directed at a protective layer for the anode active material layer (anode or negative electrode) for a lithium secondary battery, which is preferably a secondary battery based on a non-aqueous electrolyte, a polymer gel electrolyte, an ionic liquid electrolyte, a quasi-solid electrolyte, a solid polymer electrolyte, an inorganic solid-state electrolyte, or a composite electrolyte. The shape of a lithium secondary battery can be cylindrical, square, button-like, etc. The present disclosure is not limited to any battery shape or configuration or any type of electrolyte. For convenience, we will primarily use Si, Sn, and SnO₂ as illustrative examples of a high-capacity anode active material. This should not be construed as limiting the scope of the invention.

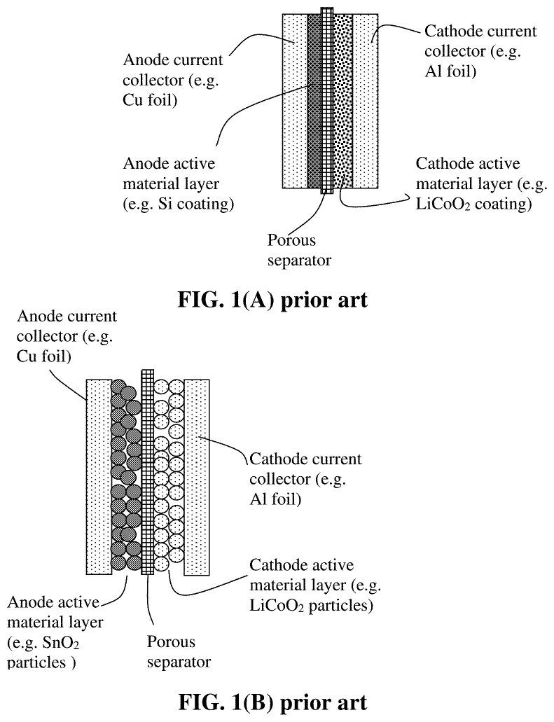

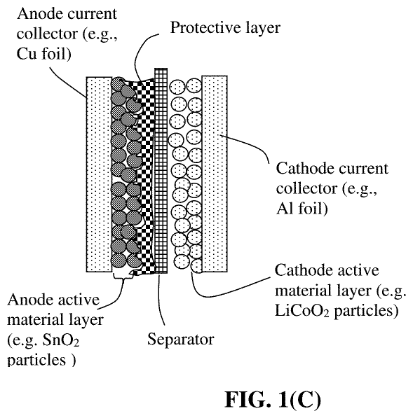

As illustrated in FIG. 1(B), a lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g., graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

In a less commonly used cell configuration, as illustrated in FIG. 1(A), the anode active material is deposited in a thin film form directly onto an anode current collector, such as a layer of Si coating deposited on a sheet of copper foil. This is not commonly used in the battery industry and, hence, will not be discussed further.

In order to obtain a higher energy density cell, the anode in FIG. 1(B) can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials.

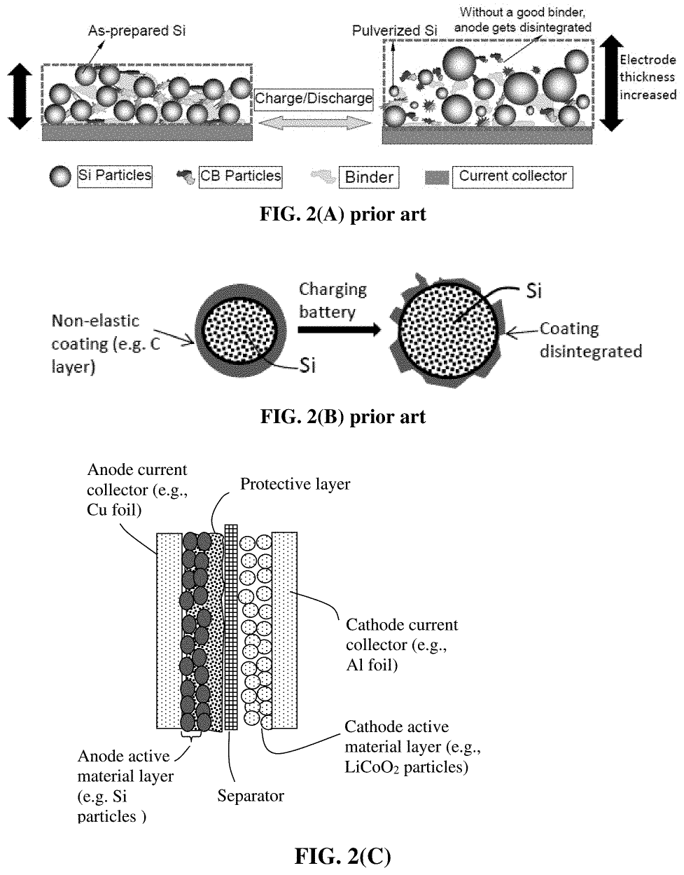

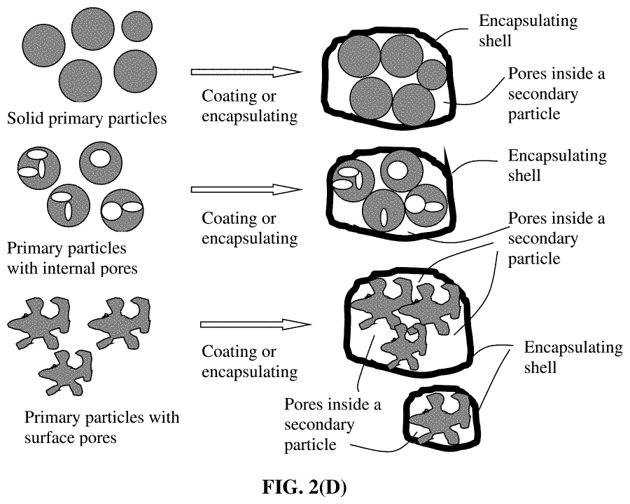

As schematically illustrated in FIG. 2(A), one major problem is the notion that, in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction of the active material particles leads to the pulverization of active material particles and detachment of the binder resin from the particles, resulting in loss of contacts between active material particles and conductive additives and loss of contacts between the anode active material and its current collector. These adverse effects of anode electrode disintegration result in a significantly shortened charge-discharge cycle life.

We have solved these challenging issues that have troubled battery designers and electrochemists alike for more than 30 years by combining the following approaches: (a) implementing a protective layer between the anode and the separator layer, (b) allowing some of the elastic, ion-conducting polymer in this protective layer to permeate into the anode electrode layer, making ionic or physical contact with particles of the anode active material (preferably making contacts with substantially all the anode particles), and (c) optionally implementing a controlled amount of pores in the electrode to facilitate permeation of the elastic, ion-conducting polymer and to accommodate the expanded volume of the anode active material particles during battery charges, reducing or eliminating the thickness change (swelling) of the anode electrode. Preferably, the ion-conducting polymer is also electron-conducting. The lithium ion conductivity is preferably no less than 10⁻⁶ S/cm and the electrical conductivity of the polymer is preferably from 10⁻⁶ S/cm to 10³ S/cm.

The present disclosure provides a lithium-ion cell comprising an anode, a cathode, an optional separator layer (e.g., an ion-conducting membrane, a combined separator/electrolyte layer, such as a liquid electrolyte-soaked polymer membrane, or just a solid electrolyte layer as a separator) disposed between the anode and the cathode, and an elastic, ion-conducting polymer protective layer disposed between the anode and the separator layer (if present) or between the anode and the cathode (if no separator), wherein the anode comprises multiple particles of an anode active material, an optional conductive additive, and an optional polymer binder that bonds the anode material particles and the conductive additive together to form the anode and wherein the polymer protective layer comprises an elastic polymer having a recoverable tensile strain from 5% to 1,000%, when measured without an additive dispersed in the elastic polymer and a lithium ion conductivity no less than 10⁻⁶ S/cm.

Preferably, the anode comprises pores having a pore volume fraction from 10% to 80% based on the total anode electrode volume but excluding the volume of the anode current collector, if present, in such a manner that the volume expansion of the anode electrode during battery charge/discharge operations is from 0% to 30%.

In certain embodiments, the polymer protective layer comprises an elastomer or rubber selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, epichlorohydrin rubber, polyacrylic rubber, silicone rubber, polysiloxane, poly(alkyl siloxane), fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea polymer, a copolymer thereof, a chemical derivative thereof, a sulfonated version thereof, or a combination thereof.

The elastomer or rubber may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In certain embodiments, the polymer protective layer comprises chains of a conducting conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. The electrical conductivity of the polymer is preferably from 10⁻⁶ S/cm to 10³ S/cm.

Preferably, the elastic polymer permeates into pores of the anode and is in ionic or physical contact with the multiple particles of the anode active material. Preferably, the elastic polymer is in physical contact with substantially all of the anode material particles and covers most of the exposed surfaces of the anode material particles. This elastic polymer in the protective layer can help hold the electrode active material particles and the conductive additive together even when the electrode active material particles undergo large volume expansions or pulverization during battery charge/discharge operations.

In certain embodiments, the multiple particles comprise porous primary particles, porous secondary particles, or a combination of porous primary and secondary particles. The primary particles can be porous having internal pores or surface pores, as illustrated in FIG. 2(E). When one or a plurality of solid or porous primary particles are encapsulated by a shell to form secondary particles (particulates), these secondary particles can contain pores inside the constituent primary particles or between the primary particles and the encapsulating shell.

In some embodiments, the total pore volume fraction Vt is from 20% to 70% or the volume expansion of the electrode in a battery cell during battery charge/discharge operations does not exceed 10%. The high-elasticity polymer has a recoverable tensile strain no less than 5% when measured without an additive or reinforcement in the polymer under uniaxial tension and preferably a lithium ion conductivity no less than 10⁻⁶ S/cm at room temperature (preferably no less than 10⁻⁵ S/cm and more preferably and typically no less than 10⁻⁴ S/cm). The anode active material is preferably a high-capacity anode material that has a specific capacity of lithium storage greater than 372 mAh/g, which is the theoretical capacity of graphite.

The elastic polymer refers to a polymer, typically a lightly cross-linked polymer, which exhibits an elastic deformation that is at least 5% when measured (without an additive or reinforcement in the polymer) under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 30%, more preferably greater than 50%, further more preferably greater than 100%, still more preferably greater than 150%, and most preferably greater than 200%. The preferred types of elastic (or high-elasticity) polymers will be discussed later.

As schematically illustrated in FIG. 2(B), volume expansion of a Si particle (coated with a non-elastic coating, such as carbon), as induced by lithium intercalation during charging of a lithium-ion battery, can lead to disintegration of the coating layer. If this coating layer contains a solid-electrolyte interface (SEI) material, the SEI layer will be destructed and new SEI will be formed during the next charge/discharge cycles, which consumes electrolyte and lithium ions, leading to a rapid decay of the battery capacity.

According to some embodiments of the disclosure, FIG. 2(C) schematically illustrates an anode electrode having a protective layer of a high-elasticity polymer disposed between an anode active layer and a separator. This protective layer has an elastic polymer that permeates into pores of the anode electrode and comes in contact with substantially all the anode active material particles.

As illustrated in FIG. 2(D), a porous secondary particle (or porous particulate) may be produced from one or multiple primary particles which are porous (having internal pores or surface pores) or non-porous. The pores of the primary particles can allow the particle to expand into the free space without a significant overall volume increase of the particulate and without inducing any significant volume expansion of the entire anode electrode. The primary anode active material particles are preferably porous, having surface pores or internal pores, as schematically illustrated in FIG. 2(D). The production methods of porous particles are well-known in the art. For instance, the production of porous Si particles may be accomplished by etching particles of a Si—Al alloy using HCl solution (to remove the Al element leaving behind pores) or by etching particles of a Si—SiO₂ mixture using HF solution (by removing SiO₂ to create pores).

All types of porous anode active material particles may be produced by depositing the anode active material onto surfaces or into pores of a sacrificial material structure, followed by removing the sacrificial material. Such a deposition can be conducted using CVD, plasma-enhanced CVD, physical vapor deposition, sputtering, solution deposition, melt impregnation, chemical reaction deposition, etc.

The anode active material may be selected from the group consisting of: (a) silicon (Si), germanium (Ge), tin (Sn), lead (Pb), phosphorus (P), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide (e.g. various vanadium oxides, lithium titanium niobium oxides, etc.), ZnCo₂O₄; (f) graphite and carbon; (g) prelithiated versions thereof; (h) lithium metal or lithium alloy particles; and (i) combinations thereof.

Pre-lithiation of an anode active material can be conducted by several methods (chemical intercalation, ion implementation, and electrochemical intercalation). Among these, the electrochemical intercalation is the most effective. Lithium ions can be intercalated into non-Li elements (e.g., Si, Ge, and Sn) and compounds (e.g. SnO₂ and Co₃O₄) up to a weight percentage of 54.68% (see Table 1 below). For Zn, Mg, Ag, and Au encapsulated inside an elastomer shell, the amount of Li can reach 99% by weight.

TABLE 1
Lithium storage capacity of selected non-Li elements.

| Intercalated | Atomic weight | Atomic weight of | Max. wt. % |
|---|---|---|---|
| compound | of Li, g/mole | active material, g/mole | of Li |
| Li₄Si | 6.941 | 28.086 | 49.71 |
| Li_{4.4}Si | 6.941 | 28.086 | 54.68 |
| Li_{4.4}Ge | 6.941 | 72.61 | 30.43 |
| Li4.4Sn | 6.941 | 118.71 | 20.85 |
| Li₃Cd | 6.941 | 112.411 | 14.86 |
| Li₃Sb | 6.941 | 121.76 | 13.93 |
| Li_{4.4}Pb | 6.941 | 207.2 | 13.00 |
| LiZn | 6.941 | 65.39 | 7.45 |
| Li₃Bi | 6.941 | 208.98 | 8.80 |

The particles of the anode active material may be in the form of a nano particle, nano wire, nano fiber, nano tube, nano sheet, nano platelet, nano disc, nano belt, nano ribbon, or nano horn. They can be non-lithiated (when incorporated into the anode active material layer) or pre-lithiated to a desired extent (up to the maximum capacity as allowed for a specific element or compound. In some embodiments, the anode active material contains a sub-micron or micron particle having a dimension from 100 nm to 30 μm.

Preferably, the high-elasticity polymer in the anode-protecting layer has a lithium ion conductivity no less than 10⁻⁵ S/cm, more preferably no less than 10⁻⁴ S/cm, further preferably no less than 10⁻³ S/cm, and most preferably no less than 10⁻² S/cm. In some embodiments, the high-elasticity polymer is a polymer matrix composite containing from 0.01% to 50% (preferably 0.1% to 35%) by weight of a lithium ion-conducting material dispersed in a high-elasticity polymer matrix material. The high-elasticity polymer should have a high elasticity (elastic deformation strain value >5%). An elastic deformation is a deformation that is fully recoverable and the recovery process is essentially instantaneous (no significant time delay). The high-elasticity polymer can exhibit an elastic deformation from 5% up to 1,000% (10 times of its original length), more typically from 10% to 800%, and further more typically from 50% to 500%, and most typically and desirably from 70% to 300%. It may be noted that although a metal typically has a high ductility (i.e., can be extended to a large extent without breakage), the majority of the deformation is plastic deformation (non-recoverable) and only a small amount of elastic deformation (typically <1% and more typically <0.2%).

In some preferred embodiments, the high-elasticity polymer contains a lightly cross-linked network of polymer chains. These chains preferably have an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

The high-elasticity polymer may contain a conducting polymer network of cross-linked chains comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

Typically, a high-elasticity polymer is originally in a monomer or oligomer state that can be polymerized and/or cured to form a cross-linked polymer that is highly elastic. Prior to curing, these polymers or oligomers are soluble in an organic solvent to form a polymer solution. In some cases, the monomers are in a liquid state and may not require a solvent as a liquid medium. This reactive solution is then sprayed, casted, or coated onto a porous anode electrode to form a protective layer thereto. The porous anode electrode may be prepared using a known process (e.g., slurry coating). The porous anode typically contains multiple particles of an anode active material (e.g., SiO and SnO₂ nano particles and Si nano-wires), a conductive filler and/or reinforcement material (e.g., CNTs, carbon nano-fibers, graphene sheets, expanded graphite flakes, etc.), a resin binder, and pores. Upon spraying, casting, or coating, some of the reactive solution can permeate into pores of the anode electrode and the remaining portion resides between the anode electrode and the separator.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC) to form a solution. Then, the solution is be spray-coated onto a porous anode layer (supported on a Cu foil). This coating layer can then be thermally cured to obtain an anode-protecting layer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

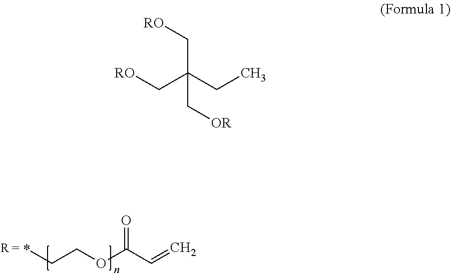

As another example, the high-elasticity polymer may be based on cationic polymerization and cross-linking of the cyanoethyl polyvinyl alcohol (PVA-CN, Formula 2) in succinonitrile (SN).

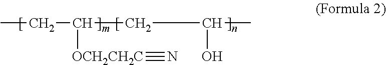

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. The solution may be sprayed over a porous anode layer to form a protective layer, which can then be heated at a temperature (e.g., from 75 to 100° C.) for 2 to 8 hours to obtain high-elasticity polymer. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains that chemically bond to the active material particles. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, p is the physical density, R is the universal gas constant in J/mol*K and T is absolute temperature in K. Once Ge and p are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g., random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range of 10⁻⁴ to 5×10⁻³ S/cm.

The aforementioned high-elasticity polymers may be used alone to chemically bond the anode active material particles (as a binder polymer) or to encapsulate electrode active material particles (as a coating polymer). Alternatively, the high-elasticity polymer can be mixed with a broad array of elastomers, electrically conducting polymers, lithium ion-conducting materials, and/or strengthening materials (e.g., carbon nanotube, carbon nano-fiber, or graphene sheets).

A broad array of elastomers can be part of a high-elasticity polymer to bond the anode active material particles together in an anode layer. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly(tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a high-elasticity polymer comprises a lithium ion-conducting material dispersed in the high-elasticity polymer. The lithium ion-conducting material may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4. In some embodiments, the lithium ion-conducting material contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The ion-conducting material may contain an inorganic solid electrolyte material selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the elastic polymer layer include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₄₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₂ (A=Ca, Sr or Ba; M=Nb or Ta), Li_{5.5}La₃M_{1.75}B_{0.25}O₁₂ (M=Nb or Ta; B═In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S, system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEI. Preferably and typically, the elastic polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

The high-elasticity polymer may form a mixture, blend, or semi-interpenetrating network with an electron-conducting polymer selected from polyaniline, polypyrrole, polythiophene, polyfuran, a bi-cyclic polymer, derivatives thereof (e.g., sulfonated versions), or a combination thereof.

In some embodiments, the high-elasticity polymer may form a mixture, blend, or semi-interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

Unsaturated rubbers that can be part of a high-elasticity polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g., by having a copolymer domain that holds other linear chains together.

Polyurethane and its copolymers (e.g., urea-urethane copolymer) are particularly useful elastomeric binder materials for bonding anode active material particles. The starting materials for a polyurethane, a polyol and a diisocyanate, are typically in a liquid state to begin with and hence are particularly convenient materials to combine with the anode active material particles and the conductive reinforcement materials to form a slurry.

The protective layer formulation typically requires the high-elasticity polymer or its precursor (monomer or oligomer) to be dissolvable in a solvent. Fortunately, all the high-elasticity polymers or their precursors used herein are soluble in some common solvents or themselves are in a liquid state before polymerization begins. The un-cured polymer or its precursor can be readily dissolved in a common organic solvent to form a solution. This solution can then be sprayed, coated, or casted over an anode layer. Upon contact with active material particles, the precursor in the protective layer is then polymerized and cross-linked.

A method of producing an elastic polymer protective layer includes using a known procedure (e.g., slurry coating) to produce an anode electrode onto a surface of a current collector (e.g., Cu foil). This procedure is essentially identical or very similar to the current slurry coating process commonly used in lithium-ion battery. Hence, there is no need to change the production equipment or facility. The polymer precursor solution is then coated or deposited onto a surface of the anode, allowing the solution to permeate into pores of the anode. The liquid medium of the solution is then removed to form a dried layer containing the polymer precursor (monomer or oligomer). This dried layer is exposed to heat and/or UV light to initiate the polymerization and/or cross-linking reactions that harden the resin which can bond to the anode particles.

During the formation procedure of the anode electrode layer, one may choose to introduce a blowing agent (foaming agent) into the electrode layer to produce pores in a controlled manner. A sufficient amount of pores in the anode can significantly increase the cycle life of a lithium-ion battery featuring such an anode electrode.

In some preferred embodiments, pores can be introduced into an electrode by adding a blowing agent into the electrode layer structure being formed on a current collector surface. One may choose to use a chemical foaming agent and/or a physical foaming agent.

Chemical foaming agents (CFAs) can be organic or inorganic compounds that release gasses upon thermal decomposition. CFAs are typically used to obtain medium- to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range of 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CFAs fall into the range of our heat treatment temperatures. Examples of suitable chemical blowing agents include sodium bi-carbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4. 4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in an electrode for a lithium-ion battery. We have surprisingly observed that a physical blowing agent (e.g. CO₂ or N₂) can be injected into the stream of elastic polymer curing or polymerization suspension prior to being coated or cast onto the supporting substrate (e.g. Cu foil). This would result in a foamed structure even when the liquid medium is removed.

Technically feasible blowing agents include Carbon dioxide (CO₂), Nitrogen (N₂), Isobutane (C₄H₁₀), Cyclopentane (C₅H₁₀), Isopentane (C₅H₁₂), CFC-11 (CFCI₃), HCFC-22 (CHF₂CI), HCFC-142b (CF₂CICH₃), and HCFC-134a (CH₂FCF₃). However, in selecting a blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-HA material weight ratio, which is typically from 0/1.0 to 1.0/1.0.

The present disclosure also provides a method of manufacturing a lithium battery cell, the method comprising: (a) preparing an anode by (i) dispersing multiple particles of an anode active material, a conductive additive, and a resin binder in a liquid medium to form a slurry; (ii) coating or casting the slurry onto at least a primary surface of an anode current collector; and (iii) removing the liquid medium to form an anode electrode comprising an anode active layer supported on the anode current collector; (b) depositing a protective polymer layer onto a primary surface of the anode active layer to form a protected anode electrode, wherein the protective polymer layer comprises an elastic, ion-conducting polymer having a recoverable tensile strain from 5% to 1,000%, when measured without an additive or reinforcement dispersed in the polymer, and a lithium ion conductivity no less than 10⁻⁶ S/cm; and (c) combining the protected anode electrode, a separator or combined separator/electrolyte, a cathode, and a protective casing to form the lithium-ion cell.

In some embodiments, step (b) comprises the following procedures (A) and/or (B):
A) comprises (i) dispersing or dissolving the elastic, ion-conducting polymer (optionally along with a curing agent or crosslinking agent) in a liquid solvent to form a polymer solution, (ii) spraying, casting, or coating the polymer solution onto the primary surface of the anode active layer, and (iii) removing the liquid solvent to form a dry protective layer (step (A) may optionally include a procedure of crosslinking the polymer); and/or
B) comprises preparing a liquid reactive mixture comprising a monomer or oligomer, an initiator and/or a crosslinking agent, depositing the liquid reactive mixture onto the primary surface of the anode active layer, and effecting a polymerization and/or crosslinking procedure to form the elastic, ion-conducting polymer which is in ionic or physical contact with the multiple anode active material particles.

In some embodiments, step (a) comprises producing pores in the anode active layer and step (b) comprises permeation of the elastic polymer or its precursor into the pores so that the elastic polymer comes in ionic or physical contact with the multiple anode active material particles.

### Example 1: High-Elasticity Polymer-Protected Anode Layer Containing Cobalt Oxide (Co₃O₄) Anode Particulates

An appropriate amount of inorganic salts Co(NO₃)₂·6H₂O and ammonia solution (NH₃·H₂O, 25 wt. %) were mixed together. The resulting suspension was stirred for several hours under an argon flow to ensure a complete reaction. The obtained Co(OH)₂ precursor suspension was calcined at 450° C. in air for 2 h to form particles of the layered Co₃O₄. Portion of the Co₃O₄ particles, along with graphitic nano-fibers (GNFs) as a conductive additive, was then made into a porous anode active material layer.

For the preparation of an anode-protective layer, the ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratios of the ETPTA/solvent of 3/97 (w/w). Subsequently, benzoyl peroxide (BPO, 1.0 wt. % relative to the ETPTA content) was added as a radical initiator to form a reactive solution. The reactive solution was then sprayed over a surface of the porous anode layer supported on a Cu foil, allowing the reactive solution to permeate into pores in the anode layer. This layer was then thermally cured at 60° C. for 30 min to obtain an anode-protecting layer.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking.

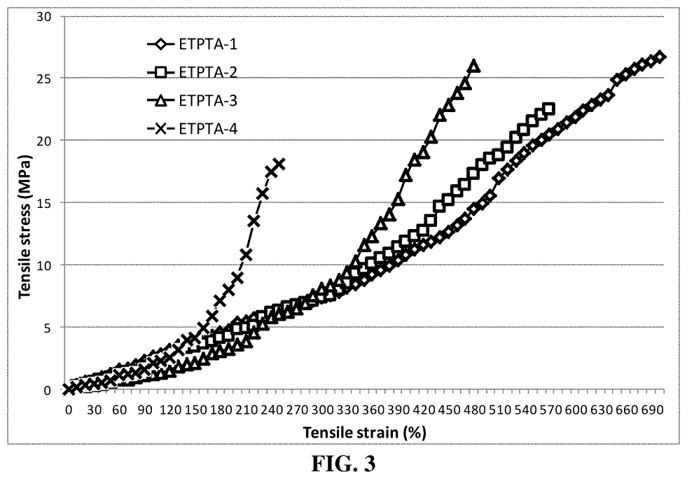

Several tensile testing specimens were cut from each cross-link film and tested with a universal testing machine. The representative tensile stress-strain curves of four BPO-initiated cross-linked ETPTA polymers are shown in FIG. 3, which indicate that this series of network polymers have an elastic deformation from approximately 230% to 700%. These values are for neat polymers without any additive. The addition of up to 30% by weight of a lithium salt typically reduces this elasticity down to a reversible tensile strain from 10% to 100%.

Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using an electrochemical workstation at a scanning rate of 1 mV/s. The electrochemical performance of the cell featuring high-elasticity polymer protective layer were evaluated by galvanostatic charge/discharge cycling at a current density of 50-500 mA/g, using a LAND electrochemical workstation.

It may be noted that the number of charge-discharge cycles at which the specific capacity decays to 80% of its initial value is commonly defined as the useful cycle life of a lithium-ion battery. The elastic polymer layer has been to be highly effective in protecting the anode active layer, helping to significantly extend the cycle life of the cell.

The high-elasticity polymer as an anode-protecting layer appears to be capable of reversibly deforming without breakage when the anode active material particles expand and shrink. The polymer also helps to hold the active material particles and the conductive fibers together, ensuring the structural integrity of the entire anode electrode when these particles expand or shrink. These were observed by using SEM to examine the surfaces of the electrodes recovered from the battery cells after some numbers of charge-discharge cycles.

### Example 2: High-Elasticity Polymer-Protected Anode Layer Featuring Tin Oxide Particulates as an Anode Active Material

Tin oxide (SnO₂) nano particles were obtained by the controlled hydrolysis of SnCl₄·5H₂O with NaOH using the following procedure: SnCl₄·5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 min. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere. Subsequently, particles of a selected anode active material (SnO₂ and graphene-embraced SnO₂ particles) and graphene oxide sheets (as a conductive additive) were introduced into water to form a series of slurries. The slurry was coated onto a Cu foil and dried to form a porous anode electrode.

The high-elasticity polymer for protecting the anode active layer containing SnO₂ nano particles was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium salt into the high elasticity polymer, we chose to use LiPF₆ as an initiator. The ratio between LiPF₆ and the PVA-CN/SN mixture solution was varied from 1/20 to 1/2 by weight to form a series of precursor solutions. The precursor solutions were then separately coated onto a surface of an anode electrode, allowing the reactive solution to permeate into pores of the anode electrode. The reactive layer was then heated at a temperature from 75 to 100° C. for 2 to 8 hours to obtain a layer of high-elasticity polymer.

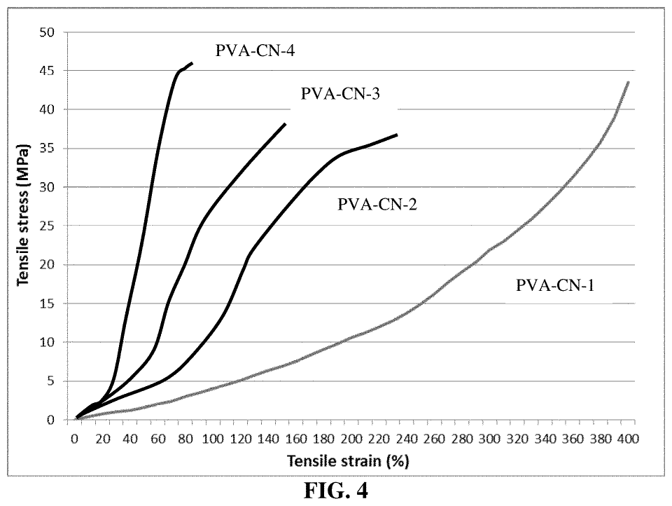

Additionally, the reacting mass, PVA-CN/LiPF₆, was cast onto a glass surface to form several films which were polymerized and cross-linked to obtain cross-linked polymers having different degrees of cross-linking. Tensile testing was also conducted on these films and some testing results are summarized in FIG. 4. This series of cross-linked polymers can be elastically stretched up to approximately 80% (higher degree of cross-linking) to 400% (lower degree of cross-linking).

Similar slurry coating procedures were used to produce cathodes that contain well-known NCM, NCA, and LFP particles as the cathode active materials. A battery cell was then made from a high-elasticity polymer-protected anode layer, a polymer membrane separator, and a cathode layer to form a cell.

### Example 3: Tin (Sn) Nano Particle-Based Anode Layer Protected by a PETEA-Based High-Elasticity Polymer Layer

For serving as an anode-protecting layer, pentaerythritol tetraacrylate (PETEA), Formula 3, was used as a monomer:

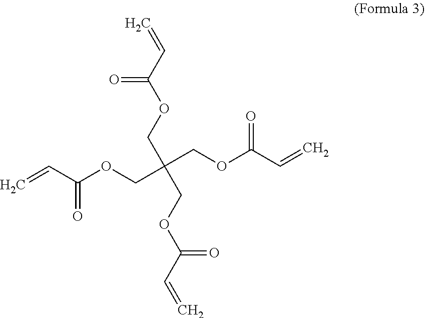 [SMILES: C=CC(=O)OCC(COC(=O)C=C)(COC(=O)C=C)COC(=O)C=C]

The precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME)(1:1 by volume) to obtain a reactive precursor solution.

Nano particles (76 nm in diameter) of Sn and expanded graphite flakes (graphite-to-Sn ratio=10/90) were dispersed into NMP to form a slurry, which was coated onto a Cu foil and dried to form an anode electrode. The reactive precursor solution of PETEA/AIBN was then coated onto an anode electrode surface and polymerized and cured at 70° C. for half an hour to obtain an anode-protecting layer.

The reacting mass, PETEA/AIBN alone was cast onto a glass surface to form several films which were polymerized and cured to obtain cross-linked polymers having different degrees of cross-linking. Tensile testing was also conducted on these films. This series of cross-linked polymers can be elastically stretched up to approximately 25% (higher degree of cross-linking) or to 80% (lower degree of cross-linking)

### Example 4: High-Elasticity Polymer-Protected Anode Containing Si Nanowires as an Anode Active Material

Si nano particles and Si nanowires Si nano particles are available from Angstron Energy Co. (Dayton, Ohio). Si nanowires, mixtures of Si and carbon, and their graphene sheets-embraced versions, respectively, were mixed with particles of acetylene black (a conductive additive) and CMC polymer as a binder resin to form a porous anode layer over a sheet of Cu foil using slurry coating.

The protective elastic polymer layer is based on semi-interpenetrating network polymer of ETPTA/EGMEA. The ETPTA (Mw=428 g/mol, trivalent acrylate monomer), EGMEA (Mw=482 g/mol, monovalent acrylate oligomer), and 2-hydroxy-2-methyl-1-phenyl-1-propanone (HMPP, a photoinitiator) were dissolved in a solvent (propylene carbonate, PC) to form a solution. The weight ratio between HMPP and the ETPTA/EGMEA mixture was varied from 0.2% to 2%. The ETPTA/EGMEA proportion in the solution was varied from 1% to 5% to generate different encapsulation layer thicknesses. The ETPTA/EGMEA ratio in the acrylate mixture was varied from 10/0 to 1/9.

The reactive mixture solution was then brush-coated onto the porous anode layer. The protective layer containing ETPTA/EGMEA/HMPP was then exposed to UV irradiation for 40 s. The UV-promoted polymerization or cross-linking was conducted using a Hg UV lamp (100 W), having a radiation peak intensity of approximately 2000 mW/cm² on the surfaces of the electrodes.

### Example 5: Production of Anode-Protecting Layers Based on PEDOT:PS/CNT

Poly(3,4-ethylenedioxythiophene):polystyrene sulfonate (PEDOT:PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS is soluble in water.

Desired amounts of the graphene sheets and carbon-coated SiO particles (supplied from Angstron Energy Co., Dayton, Ohio), along with SBR binder resin, were combined and made into an anode electrode on a Cu foil surface using the conventional slurry coating. The PEDOT/PSS-water solution was then sprayed over the anode layer surface, followed by water removal via vaporization.

### Example 6: Preparation of Reactive Pyrrole-Based Conductive Polymer Network as a Protective Layer for an Anode Electrode

Particles of an anode active material (e.g., thin polyurethane-coated nano, sub-micron, or micron Si particles) and a conductive additive (CNTs and/or graphene sheets), along with SBR resin binder, were made into an anode electrode.

Polypyrrole networks (cross-linked PPy or PPy hydrogels) were prepared via a two-reactant, one-pot process. Pyrrole (>97% purity) was dissolved in a solvent of water/ethanol (1:1 by weight) to achieve the first reactant having a concentration of 0.209 mol/L. Then, as the second reactant, aqueous solutions of ferric nitrate (Fe(NO₃)₃·9H₂O) and ferric sulphate, respectively, were made at concentrations of 0.5 mol/L. Subsequently, polymerization of the network gels was carried out in an ice bath at 0° C., by mixing volumes of the two reactants at 1:1 molar ratios of pyrrole:ferric salt, to create a reacting mixture with a total of 4 mL. A desired amount of the reacting liquid mass was coated over the anode electrode layer; polymerization and gelation began after 5 minutes. A pyrrole:ferric salt molar ratio of 1:1, which was stoichiometrically deficient of ferric salt, led to secondary growth (cross-linking) of the polypyrrole network, which could continue for several days at room temperature to produce cohesive hydrogels of high elasticity upon removal of the liquid phase (water and ethanol).

### Example 7: Production of Conducting Polyaniline Network to Form an Anode Protecting Layer

The precursor of a conducting network polymer, such as cross-linkable polyaniline and polypyrrole, may contain a monomer, an initiator or catalyst, a crosslinking agent, an oxidizer and/or dopant. As an example, 3.6 ml aqueous solution A, which contains 400 mM aniline monomer and 120 mM phytic acid, was prepared. Subsequently, 1.2 ml solution B, containing 500 mM ammonium persulfate was added into the above mixture and subjected to bath sonication for 1 min. The resulting reactive suspension was coated onto an anode layer surface. In about 5-10 min, the solution changed color from brown to dark green and became viscous and gel-like, indicating in-situ polymerization of aniline monomer to form the PANi hydrogel. The resulting layer was further cured at 50° C. for 0.5-2 hours to obtain an anode-protecting layer of PANi network polymer. graphene-CNT composite bonded anode particles.

### Example 8: Elastic Polyurethane and Polysiloxane Elastomer as an Anode Protecting Layer

Twenty-four parts by weight of diphenylmethane diisocyanate and 22 parts by weigh of butylene glycol were continuously reacted with 100 parts by weight of polyethylene adipate having hydroxyl groups at both terminals (molecular weight of 2,100) with agitation at a reaction temperature of 115° C. for a reaction time of 60 minutes to give a prepolymer having hydroxyl-terminal. This prepolymer having hydroxyl-terminal had a viscosity of 4,000 cP at 70° C.

On a separate basis, 84 parts by weight of diphenylethane diisocyanate was continuously reacted with 200 parts by weight of polyethylene adipate having hydroxyl groups at both terminals (molecular weight of 2,100) with agitation at a reaction temperature of 115° C. for a reaction time of 60 minutes to give a prepolymer having isocyanate-terminal. This prepolymer having isocyanate-terminal had a viscosity of 1,500 cP at 70° C.

One hundred forty-six (146) parts by weight of the thus obtained prepolymer having hydroxyl-terminal and 284 parts by weight of the obtained prepolymer having isocyanate-terminal, were continuously injected into a heat exchange reactor and mixed and stirred at a reaction temperature of 190° C. for a residence time of 5-730 minutes. The obtained viscous product was immediately cast onto an anode layer surface to obtain a layer of elastic polymer having a thickness of approximately 51 nm, 505 nm, and 2.2 μm, respectively.

On a separate basis, a sample of reactive polysiloxane (mixed with 5% by wt. of LiF and 5% Li₂CO₃) was cast onto an anode surface and cured at 115° C. for 2 hours to form an elastic polymer film of 8-45 μm in thickness. The lithium ion conductivity of these thin films was approximately 4.5-9.5 10⁻⁵ S/cm.

### Example 9: Polyisoprene Elastomer-Based Anode-Protecting Layer

A dilute elastomer-solvent solution (0.01-0.1 M of cis-polyisoprene in cyclohexane and 1,4-dioxane) was prepared as a coating solution. Subsequently, lithium hexafluoro phosphate, as a lithium salt, was added and dissolved in the above solution. The solution was then cast over an anode electrode (containing graphene-encapsulated Si particles as an anode active material).

A lithium-ion cell was made, comprising the anode layer, the protecting layer adhered to the anode layer, a solid-state electrolyte separator, a cathode (comprising 75% by weight of LiCoO₂ as the cathode active material, 15% of hybrid particulates, 5% PVDF binder, and 5% combined graphene/CNT as a conductive additive). The solid-state electrolyte-based separator was made to be composed of particles of Li₇La₃Zr₂O₁₂ embedded in a poly(vinylidene fluoride)-hexafluoropropylene (PVDF-HFP) matrix (inorganic solid electrolyte/PVDF-HFP ratio=4/6).

### Example 10: Sulfonated Polybutadiene (PB) Elastomer as an Anode-Protecting Layer Material

Sulfonated PB may be obtained by free radical addition of thiolacetic acid (TAA) followed by in Situ oxidation with performic acid. A representative procedure is given as follows. PB (8.0 g) was dissolved in toluene (800 mL) under vigorous stirring for 72 h at room temperature in a 1 L round-bottom flask. Benzophenone (BZP) (0.225 g; 1.23 mmol; BZP/olefin molar ratio=1:120) and TAA (11.9 mL; 0.163 mol, TAA/olefin molar ratio=1.1) were introduced into the reactor and the polymer solution was irradiated for 1 h at room temperature with UV light of 365 nm and power of 100 W.

The resulting thio-acetylated polybutadiene (PB-TA) was isolated by pouring 200 mL of the toluene solution in a plenty of methanol and the polymer recovered by filtration, washed with fresh methanol, and dried in vacuum at room temperature. Formic acid (117 mL; 3.06 mol; HCOOH/olefin molar ratio=25), along with a desired amount of and a desired amount (0.1%-40% by wt.) of lithium salt (LiPF₆ and lithium trifluoromethanesulfonimide or LiTFSI, respectively), were added to the toluene solution of PB-TA at 50° C. followed by slow addition of 52.6 mL of hydrogen peroxide (35 wt %; 0.61 mol; H₂O₂/olefin molar ratio=5) in 20 min. We would like to caution that the reaction is autocatalytic and strongly exothermic. The resulting solution was coated onto an anode layer to obtain sulfonated polybutadiene-protected anode electrode.

### Example 11: Effect of Lithium Ion-Conducting Additive in a High-Elasticity Polymer Binder

A wide variety of lithium ion-conducting additives were added to several different polymer matrix materials to prepare a protective polymer layer. The polymer preferably has a lithium ion conductivity at room temperature no less than 10⁻⁶ S/cm, preferably higher than 10⁻⁵ S/cm. Some lithium ion conductivity data are given in Table 2 below.

TABLE 2
Lithium ion conductivity values of various high-elasticity polymer
compositions as an anode-protecting layer material.

| Sam- | Lithium- | | |
|---|---|---|---|
| ple | conducting | | |
| No. | additive | Elastomer layer | Li-ion conductivity (S/cm) |
| E-1b | Li₂CO₃ + | 70-99% PVA-CN | 2.9 × 10⁻⁴ to 3.6 × 10⁻³ |
| | (CH₂OCO₂Li)₂ | | S/cm |
| E-2b | Li₂CO₃ + | 65-99% ETPTA | 6.4 × 10⁻⁴ to 2.3 × 10⁻³ |
| | (CH₂OCO₂Li)₂ | | S/cm |
| E-3b | Li₂CO₃ + | 65-99% ETPTA/ | 8.4 × 10⁻⁴ to 1.8 × 10⁻³ |
| | (CH₂OCO₂Li)₂ | EGMEA | S/cm |
| D-4b | Li₂CO₃ + | 70-99% PETEA | 7.8 × 10⁻³ to 2.3 × 10⁻² |
| | (CH₂OCO₂Li)₂ | | S/cm |
| D-5b | Li₂CO₃ + | 75-99% PVA-CN | 8.9 × 10⁻⁴ to 5.5 × 10⁻³ |
| | (CH₂OCO₂Li)₂ | | S/cm |
| B1b | LiF + LiOH + | 60-90% PVA-CN | 8.7 × 10⁻⁵ to 2.3 × 10⁻³ |
| | Li₂C₂O₄ | | S/cm |
| B2b | LiF + HCOLi | 80-99% PVA-CN | 2.8 × 10⁻⁴ to 1.6 × 10⁻³ |
| | | | S/cm |
| B3b | LiOH | 70-99% PETEA | 4.8 × 10⁻³ to 1.2 × 10⁻² |
| | | | S/cm |
| B4b | Li₂CO₃ | 70-99% PETEA | 4.4 × 10⁻³ to 9.9 × 10⁻³ |
| | | | S/cm |
| B5b | Li₂C₂O₄ | 70-99% PETEA | 1.3 × 10⁻³ to 1.2 × 10⁻² |
| | | | S/cm |
| B6b | Li₂CO₃ + | 70-99% PETEA | 1.4 × 10⁻³ to 1.6 × 10⁻² |
| | LiOH | | S/cm |
| C1b | LiClO₄ | 70-99% PVA-CN | 4.5 × 10⁻⁴ to 2.4 × 10⁻³ |
| | | | S/cm |
| C2b | LiPF₆ | 70-99% PVA-CN | 3.4 × 10⁻⁴ to 7.2 × 10⁻³ |
| | | | S/cm |
| C3b | LiBF₄ | 70-99% PVA-CN | 1.1 × 10⁻⁴ to 1.8 × 10⁻³ |
| | | | S/cm |
| C4b | LiBOB + | 70-99% PVA-CN | 2.2 × 10⁻⁴ to 4.3 × 10⁻³ |
| | LiNO₃ | | S/cm |
| S1b | Sulfonated | 85-99% ETPTA | 9.8 × 10⁻⁵ to 9.2 × 10⁻⁴ |
| | polyaniline | | S/cm |
| S2b | Sulfonated | 85-99% ETPTA | 1.2 × 10⁻⁴ to 1.0 × 10⁻³ |
| | SBR | | S/cm |
| S3b | Sulfonated | 80-99% ETPTA/ | 3.5 × 10⁻⁴ to 2.1 × 10⁻⁴ |
| | PVDF | EGMEA | S/cm |
| S4b | Polyethylene | 80-99% ETPTA/ | 4.9 × 10⁻⁴ to 3.7 × 103⁴ |
| | oxide | EGMEA | S/cm |

We claim:

1. A lithium-ion cell comprising an anode, a cathode, and an elastic and ion-conducting polymer protective layer disposed between the anode and the cathode, wherein the anode comprises multiple particles of an anode active material, and wherein the polymer protective layer comprises an elastic polymer having a recoverable tensile strain from 5% to 1,000%, when measured without an additive dispersed in said elastic polymer, and a lithium ion conductivity no less than 10⁻⁶ S/cm.

2. The lithium-ion cell of claim 1, wherein the anode comprises multiple pores having a pore volume fraction from 10% to 80% based on the total anode electrode volume excluding the volume of an anode current collector, if present, in such a manner that a volume expansion of the anode electrode during battery charge/discharge operations is from 0% to 30%.

3. The lithium-ion cell of claim 1, wherein the polymer protective layer comprises an elastomer or rubber selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, epichlorohydrin rubber, polyacrylic rubber, silicone rubber, polysiloxane, poly(alkyl siloxane), fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea polymer, a copolymer thereof, a chemical derivative thereof, a sulfonated version thereof, or a combination thereof.

4. The lithium-ion cell of claim 1, wherein the polymer protective layer comprises chains of a conducting conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

5. The lithium-ion cell of claim 1, wherein the elastic polymer permeates into pores of the anode and is in ionic or physical contact with said multiple particles of the anode active material.

6. The lithium-ion cell of claim 1, wherein said multiple anode material particles comprise porous primary particles, porous secondary particles, or a combination of porous primary and secondary particles.

7. The lithium-ion cell of claim 1, wherein the elastic polymer has a recoverable tensile strain from 10% to 700%, a lithium ion conductivity from 5×10⁻² S/cm to 10⁻⁵ S/cm, and/or an electrical conductivity from 10⁻⁶ S/cm to 10³ S/cm.

8. The lithium-ion cell of claim 1, wherein the polymer binder comprises a high-elasticity polymer having a recoverable tensile strain from 5% to 700%, when measured without an additive dispersed in said polymer binder.

9. The lithium-ion cell of claim 1, wherein said conductive additive is selected from the group consisting of carbon nanotubes, graphene sheets, carbon nano-fibers, graphite nano-fibers, carbon fibers, graphite fibers, expanded graphite flakes, carbon black, acetylene black, carbon particles, graphite particles, metal nanowires or whiskers, and combinations thereof.

10. The lithium-ion cell of claim 1, wherein the multiple anode material particles are coated with or encapsulated by a carbon, graphene, or graphite material.

11. The lithium-ion cell of claim 1, wherein said elastic polymer comprises a cross-linked network of polymer chains comprising an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

12. The lithium-ion cell of claim 11, wherein said cross-linked network of polymer chains comprises a polymer selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

13. The lithium-ion cell of claim 11, wherein said cross-linked network of polymer chains further comprises chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

14. The lithium-ion cell of claim 1, wherein said elastic polymer further comprises a lithium-ion conducting material dispersed or dissolved in said elastic polymer.

15. The lithium-ion cell of claim 14, wherein said lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

16. The lithium-ion cell of claim 14, wherein said lithium ion-conducting material is selected from an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

17. The lithium-ion cell of claim 14, wherein said lithium ion-conducting material is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

18. The lithium-ion cell of claim 14, wherein said lithium ion-conducting material is selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

19. The lithium-ion cell of claim 1, wherein said anode active material is selected from the group consisting of: (a) silicon (Si), germanium (Ge), tin (Sn), lead (Pb), antimony (Sb), bismuth (Bi), phosphorus (P), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo₂O₄; (f) prelithiated versions thereof; (g) particles or fibers of carbon and graphite; (h) lithium metal or lithium alloy particles; and (i) combinations thereof.

20. The lithium-ion cell of claim 19, wherein said anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

21. The lithium-ion cell of claim 1, wherein said multiple anode particles comprise anode particles that are pre-intercalated or pre-doped with lithium ions to form a prelithiated anode active material having an amount of lithium from 0.1% to 54.7%% by weight of said prelithiated anode active material.

22. The lithium-ion cell of claim 1, further including a separator layer disposed between the anode and the cathode, and wherein the elastic and ion-conducting polymer protective layer is disposed between the anode and the separator layer.

23. The lithium-ion cell of claim 1, wherein the anode further includes a conductive additive and a polymer binder that bonds the anode material particles and the conductive additive together to form the anode.

24. A method of manufacturing the lithium-ion cell of claim 1, said method comprising:
(a) preparing an anode by (i) dispersing multiple particles of an anode active material, a conductive additive, and a resin binder in a liquid medium to form a slurry; (ii) coating or casting the slurry onto at least a primary surface of an anode current collector; and (iii) removing said liquid medium to form an anode electrode comprising an anode active layer supported on the anode current collector;
(b) depositing a protective polymer layer onto a primary surface of the anode active layer to form a protected anode electrode, wherein the protective polymer layer comprises an elastic, ion-conducting polymer having a recoverable tensile strain from 5% to 1,000%, when measured without an additive or reinforcement dispersed in the polymer, and a lithium ion conductivity no less than 10⁻⁶ S/cm; and
(c) combining the protected anode electrode, a separator or combined separator/electrolyte, a cathode, and a protective casing to form the lithium-ion cell.

25. The method of claim 22, wherein step (b) comprises at least one of the following procedures:
A) Dispersing or dissolving the elastic, ion-conducting polymer in a liquid solvent to form a polymer solution, spraying, casting, or coating the polymer solution onto a primary surface of the anode active layer, and removing the liquid solvent to form a dry protective layer; and
B) Preparing a liquid reactive mixture comprising a monomer or oligomer, an initiator and/or a crosslinking agent, depositing the liquid reactive mixture onto a primary surface of the anode active layer, and polymerizing and/or crosslinking the reactive mixture to form the elastic, ion-conducting polymer which is in ionic or physical contact with the multiple anode active material particles.

26. The method of claim 22, wherein step (a) comprises producing multiple pores in the anode active layer and step (b) comprises permeating the elastic polymer or its precursor into the pores so that the elastic polymer comes in ionic or physical contact with the multiple anode active material particles.

27. A lithium-ion cell comprising an anode, a cathode, a separator layer disposed between the anode and the cathode, and an elastic and ion-conducting polymer protective layer disposed between the anode and the separator layer, if present, or between the anode and the cathode, wherein the anode comprises multiple particles of an anode active material, a conductive additive, and a polymer binder that bonds the anode material particles and the conductive additive together to form the anode and wherein the polymer protective layer comprises an elastic polymer having a recoverable tensile strain from 5% to 1,000%, when measured without an additive dispersed in said elastic polymer, and a lithium ion conductivity no less than 10⁻⁶ S/cm.
